(19) United States
(12) Patent Application Publication
(10) Pub. No.: US 2011/0109729 A1
(43) Pub. Date: May 12, 2011

(54) IMAGE DISPLAY APPARATUS AND OPERATION METHOD THERFOR

(75) Inventors: Kyung Hee YOO, Seoul (KR); Sang Jun Koo, Seoul (KR); Sae Hun Jang, Seoul (KR); Uni Young Kim, Seoul (KR); Hyung Nam Lee, Seoul (KR)

(73) Assignee: LG ELECTRONICS INC., Seoul (KR)

(21) Appl. No.: 12/905,507

(22) Filed: Oct. 15, 2010

(30) Foreign Application Priority Data
Nov. 12, 2009 (KR) 10-2009-0109291

(51) Int. Cl. H04N 13/04

(52) U.S. Cl. 348/51; 348/E13.026

(57) ABSTRACT

A method for operating an image display apparatus that receives a 3D image signal and displays the 3D image signal as a 3D image, which includes displaying an image, detecting a connected external device, generating a 3D object indicating the connected external device, and displaying the 3D object. The 3D object is processed to have a different depth from the displayed image.

### CROSS-REFERENCE TO RELATED APPLICATION

This application claims the priority benefit of Korean Patent Application No. 10-2009-0109291, filed on 12 Nov. 2009, in the Korean Intellectual Property Office, the disclosure of which is incorporated herein by reference.

### BACKGROUND OF THE INVENTION

1. Field of the Invention

Embodiments described herein relate to an image display apparatus and an operation method therefor, and more particularly, to an image display apparatus and method for displaying a three-dimensional (3D) image.

2. Background of the Invention

An image display apparatus has a function of displaying images viewable to a user. The image display apparatus can display a broadcasting program selected by the user on a display from among broadcasting programs transmitted from broadcasting stations. A recent trend in broadcasting is a worldwide shift from analog broadcasting to digital broadcasting.

Digital broadcasting offers many advantages over analog broadcasting such as robustness against noise, less data loss, ease of error correction, and the ability to provide high-definition, clear images. Digital broadcasting also has allowed interactive services for viewers.

Recently, many studies have been conducted on 3D images, and 3D image techniques are becoming popular and finding their applications in a wide range of environments and technologies. Also in the digital broadcasting industry, devices for transmitting and reproducing 3D images are under development.

### BRIEF DESCRIPTION OF THE DRAWINGS

FIG. 1 illustrates a block diagram of an image display apparatus according to an exemplary embodiment of the present invention.

FIG. 2 illustrates various types of external devices that can be connected to the image display apparatus shown in FIG. 1.

FIGS. 3(a) and 3(b) illustrate block diagrams of a controller shown in FIG. 1.

FIGS. 4(a) through 4(g) illustrate how a formatter shown in FIG. 3 separates a two-dimensional (2D) image signal and a three-dimensional (3D) image signal.

FIGS. 5(a) through 5(e) illustrate various 3D image formats provided by the formatter shown in FIG. 3.

FIGS. 6(a) through 6(c) illustrate how the formatter shown in FIG. 3 scales a 3D image.

FIGS. 7A through 7C illustrate various images that can be displayed by the image display apparatus shown in FIG. 1.

FIG. 8 is a flowchart illustrating a method for operating the image display apparatus according to an exemplary embodiment of the present invention.

FIGS. 9 to 18 are views referred to for describing various examples of the method for operating the image display apparatus, illustrated in FIG. 8.

### DETAILED DESCRIPTION

Exemplary embodiments of the present invention will be described below with reference to the attached drawings.

The terms “module” and “portion” attached to describe the names of components are used herein to help the understanding of the components and thus they should not be considered as having specific meanings or roles. Accordingly, the terms “module” and “portion” may be interchangeable in their use.

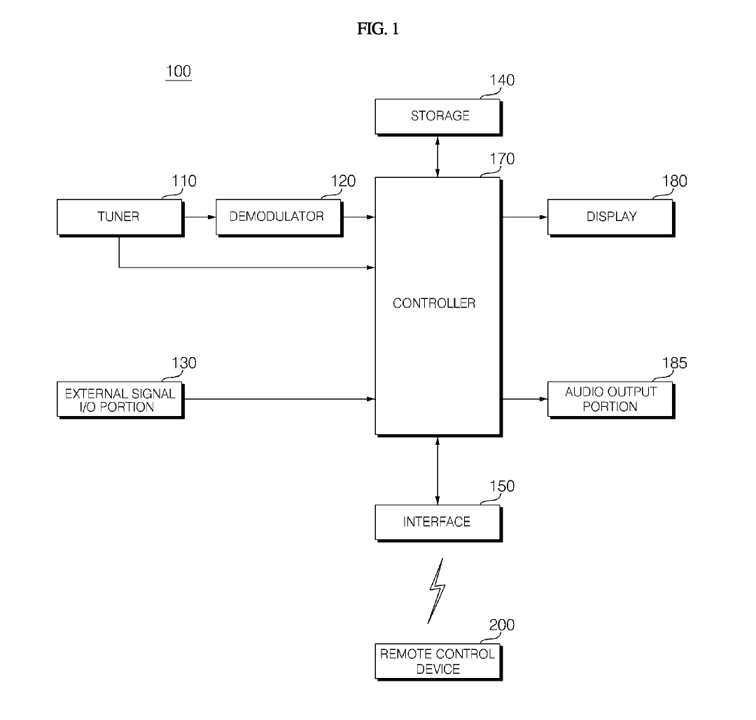

FIG. 1 illustrates a block diagram of an image display apparatus 100 according to an exemplary embodiment of the present invention. Referring to FIG. 1, the image display apparatus 100 may include a tuner 110, a demodulator 120, an external signal input/output (I/O) portion 130, a storage 140, an interface 150, a sensing portion (not shown), a controller 170, a display 180, and an audio output portion 185.

The tuner 110 may select a radio frequency (RF) broadcast signal corresponding to a channel selected by a user or an RF broadcast signal corresponding to a previously-stored channel from a plurality of RF broadcast signals received via an antenna and may convert the selected RF broadcast signal into an intermediate-frequency (IF) signal or a baseband audio/video (A/V) signal. More specifically, if the selected RF broadcast signal is a digital broadcast signal, the tuner 110 may convert the selected RF broadcast signal into a digital IF signal (DIF). On the other hand, if the selected RF broadcast signal is an analog broadcast signal, the tuner 110 may convert the selected RF broadcast signal into an analog baseband A/V signal (CVBS/SIF). That is, the tuner 110 can process both digital broadcast signals and analog broadcast signals. The analog baseband A/V signal (CVBS/SIF) may be directly transmitted to the controller 170.

The tuner 110 may be able to receive RF broadcast signals from an Advanced Television Systems Committee (ATSC) single-carrier system or from a Digital Video Broadcasting (DVB) multi-carrier system.

The tuner 110 may sequentially select a number of RF broadcast signals respectively corresponding to a number of channels previously added to the image display apparatus 100 by a channel-add function from a plurality of RF signals received through the antenna, and may convert the selected RF broadcast signals into IF signals or baseband A/V signals in order to display a thumbnail list including a plurality of thumbnail images on the display 180. Thus, the tuner 110 can receive RF broadcast signals sequentially or periodically not only from the selected channel but also from a previously-stored channel.

The demodulator 120 may receive the digital IF signal (DIF) from the tuner 110 and may demodulate the digital IF signal (DIF).

More specifically, if the digital IF signal (DIF) is, for example, an ATSC signal, the demodulator 120 may perform 8-Vestigal SideBand (VSB) demodulation on the digital IF signal DT. The demodulator 120 may perform channel decoding. For this, the demodulator 120 may include a Trellis decoder (not shown), a de-interleaver (not shown) and a Reed-Solomon decoder (not shown) and may thus be able to perform Trellis decoding, de-interleaving and Reed-Solomon decoding.

On the other hand, if the digital IF signal (DT) is, for example, a DVB signal, the demodulator 120 may perform coded orthogonal frequency division modulation (COFDMA) demodulation on the digital IF signal (DT). The demodulator 120 may perform channel decoding. For this, the demodulator 120 may include a convolution decoder (not shown), a de-interleaver (not shown), and a Reed-Solomon decoder (not shown) and may thus be able to perform convolution decoding, de-interleaving and Reed-Solomon decoding.

The demodulator 120 may perform demodulation and channel decoding on the digital IF signal (DT), thereby providing a stream signal TS into which a video signal, an audio signal and/or a data signal are multiplexed. The stream signal TS may be an MPEG-2 transport stream into which an MPEG-2 video signal and a Dolby AC-3 audio signal are multiplexed. An MPEG-2 transport stream may include a 4-byte header and a 184-byte payload.

The demodulator 120 may include an ATSC demodulator for demodulating an ATSC signal and a DVB demodulator for demodulating a DVB signal.

The stream signal TS may be transmitted to the controller 170. The controller 170 may perform demultiplexing and signal processing on the stream signal TS, thereby outputting video data and audio data to the display 180 and the audio output portion 185, respectively.

The external signal I/O portion 130 may connect the image display apparatus 100 to an external device. For this, the external signal I/O portion 130 may include an A/V I/O module or a wireless communication module.

The external signal I/O portion 130 may be connected to an external device such as a digital versatile disc (DVD), a Blu-ray disc, a game console, a camera, a camcorder, or a computer (e.g., a laptop computer) either wiredly or wirelessly. Then, the external signal I/O portion 130 may receive various video, audio and data signals from the external device and may transmit the received signals to the controller 170. In addition, the external signal I/O portion 130 may output various video, audio and data signals processed by the controller 170 to the external device.

In order to transmit A/V signals from an external device to the image display apparatus 100, the A/V I/O module of the external signal I/O portion 130 may include an Ethernet port, a universal serial bus (USB) port, a composite video banking sync (CVBS) port, a component port, a super-video (S-video) (analog) port, a digital visual interface (DVI) port, a high-definition multimedia interface (HDMI) port, a red-green-blue (RGB) port, a D-sub port, an Institute of Electrical and Electronics Engineers (IEEE)-1394 port, a Sony/Philips Digital Interconnect Format (S/PDIF) port, and a LiquidHD port.

The wireless communication module of the external signal I/O portion 130 may wirelessly access the internet, i.e., may allow the image display apparatus 100 to access a wireless internet connection. For this, the wireless communication module may use various communication standards such as a wireless local area network (WLAN) (i.e., Wi-Fi), Wireless broadband (Wibro), World Interoperability for Microwave Access (Wimax), or High Speed Downlink Packet Access (HSDPA).

In addition, the wireless communication module may perform short-range wireless communication with other electronic devices. The image display apparatus 100 may be networked with other electronic devices using various communication standards such as Bluetooth, radio-frequency identification (RFID), Infrared Data Association (IrDA), Ultra Wideband (UWB), or ZigBee.

The external signal I/O portion 130 may be connected to various set-top boxes through at least one of the Ethernet port, the USB port, the CVBS port, the component port, the S-video port, the DVI port, the HDMI port, the RGB port, the D-sub port, the IEEE-1394 port, the S/PDIF port, and the liquidHD port and may thus receive data from or transmit data to the various set-top boxes. For example, when connected to an Internet Protocol Television (IPTV) set-top box, the external signal I/O portion 130 may transmit video, audio and data signals processed by the IPTV set-top box to the controller 170 and may transmit various signals provided the controller 170 to the IPTV set-top box. In addition, video, audio and data signals processed by the IPTV set-top box may be processed by the channel-browsing processor (not shown) and then the controller 170.

The term ‘IPTV’, as used herein, may cover a broad range of services such as ADSL-TV, VDSL-TV, FTTH-TV, TV over DSL, Video over DSL, TV over IP (TVIP), Broadband TV (BTV), and Internet TV and full-browsing TV, which are capable of providing Internet-access services.

The external signal I/O portion 130 may be connected to a communication network so as to be provided with a video or voice call service. Examples of the communication network include a broadcast communication network, a public switched telephone network (PTSN), and a mobile communication network.

The storage 140 may store various programs necessary for the controller 170 to process and control signals. The storage 140 may also store video, audio and/or data signals processed by the controller 170.

The storage 140 may temporarily store video, audio and/or data signals received by the external signal I/O portion 130. In addition, the storage 140 may store information regarding a broadcast channel with the aid of a channel add function.

The storage 140 may include at least one of a flash memory-type storage medium, a hard disc-type storage medium, a multimedia card micro-type storage medium, a card-type memory (such as a secure digital (SD) or extreme digital (XD) memory), a random access memory (RAM), and a read-only memory (ROM) (such as an electrically erasable programmable ROM (EEPROM)). The image display apparatus 100 may play various files (such as a moving image file, a still image file, a music file or a document file) in the storage 140 for a user.

The storage 140 is illustrated in FIG. 1 as being separate from the controller 170, but the present invention is not restricted to this. That is, the storage 140 may be included in the controller 170.

The interface 150 may transmit a signal input thereto by a user to the controller 170 or transmit a signal provided by the controller 170 to a user. For example, the interface 150 may receive various user input signals such as a power-on/off signal, a channel-selection signal, and a channel-setting signal from a remote control device 200 or may transmit a signal provided by the controller 170 to the remote control device 200. The sensing portion may allow a user to input various user commands to the image display apparatus 100 without the need to use the remote control device 200.

The controller 170 may demultiplex an input stream provided thereto via the tuner 110 and the demodulator 120 or via the external signal I/O portion 130 into a number of signals and may process the demultiplexed signals so that the processed signals can be output A/V data. The controller 170 may control the general operation of the image display apparatus 100.

The controller 170 may control the image display apparatus 100 in accordance with a user command input thereto via the interface 150 or the sensing portion or a program present in the image display apparatus 100.

The controller 170 may include a demultiplexer (not shown), a image processor (not shown), an audio processor (not shown), and an OSD generator (not shown).

The controller 170 may control the tuner 110 to tune to select an RF broadcast program corresponding to a channel selected by a user or a previously-stored channel.

The controller 170 may demultiplex an input stream signal, e.g., an MPEG-2 TS signal, into a video signal, an audio signal and a data signal. The input stream signal may be a stream signal output by the tuner 110, the demodulator 120 or the external signal I/O portion 130.

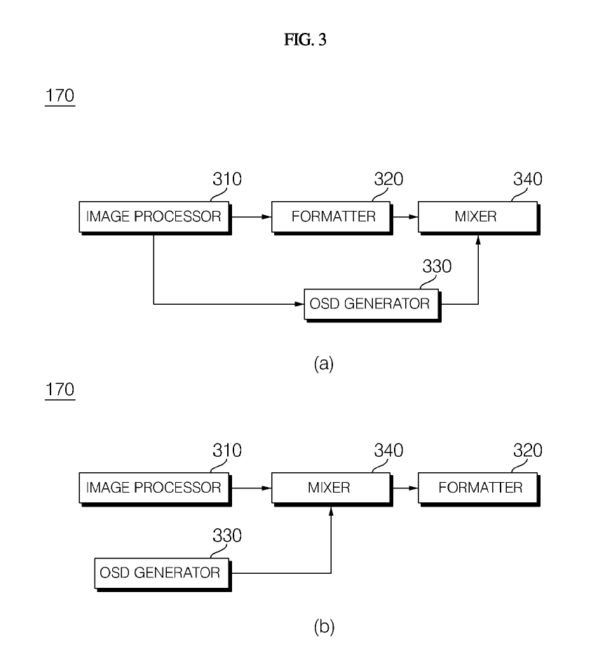

The controller 170 may process the video signal. More specifically, the controller 170 may decode the video signal using different decoder according to whether the video signal includes a 2D image signal and a 3D image signal, includes a 2D image signal only or includes a 3D image signal only. Further details about how the controller 170 processes a 2D image signal or a 3D image signal are described below with reference to FIG. 3.

In addition, the controller 170 may adjust the brightness, tint and color of the video signal.

The processed video signal provided by the controller 170 may be transmitted to the display 180 and may thus be displayed by the display 180. Then, the display 180 may display an image corresponding to the processed video signal provided by the controller 170. The processed video signal provided by the controller 170 may also be transmitted to an external output device via the external signal I/O portion 130.

The controller 170 may process the audio signal obtained by demultiplexing the input stream signal. For example, if the audio signal is an encoded signal, the controller 170 may decode the audio signal. More specifically, if the audio signal is an MPEG-2 encoded signal, the controller 170 may decode the audio signal by performing MPEG-2 decoding. On the other hand, if the audio signal is an MPEG-4 Bit Sliced Arithmetic Coding (BSAC)-encoded terrestrial DMB signal, the controller 170 may decode the audio signal by performing MPEG-4 decoding. On the other hand, if the audio signal is an MPEG-2 Advanced Audio Coding (AAC)-encoded DMB or DVB-H signal, the controller 180 may decode the audio signal by performing AAC decoding.

In addition, the controller 170 may adjust the base, treble or sound volume of the audio signal.

The processed audio signal provided by the controller 170 may be transmitted to the audio output portion 185. The processed audio signal provided by the controller 170 may also be transmitted to an external output device via the external signal I/O portion 130.

The controller 170 may process the data signal obtained by demultiplexing the input stream signal. For example, if the data signal is an encoded signal such as an electronic program guide (EPG), which is a guide to scheduled broadcast TV or radio programs, the controller 170 may decode the data signal. Examples of an EPG include ATSC-Program and System Information Protocol (PSIP) information and DVB-Service Information (SI). ATSC-PSIP information or DVB-SI information may be included in the header of a TS, i.e., a 4-byte header of an MPEG-2 TS.

The controller 170 may perform on-screen display (OSD) processing. More specifically, the controller 170 may generate an OSD signal for displaying various information on the display device 180 as graphic or text data based on a user input signal provided by the remote control device 200 or at least one of a processed video signal and a processed data signal. The OSD signal may be transmitted to the display 180 along with the processed video signal and the processed data signal.

The OSD signal may include various data such as a user-interface (UI) screen for the image display apparatus 100 and various menu screens, widgets, and icons.

The controller 170 may generate the OSD signal as a 2D image signal or a 3D image signal, and this will be described later in further detail with reference to FIG. 3.

The controller 170 may receive the analog baseband A/V signal CVBS/SIF from the tuner 110 or the external signal I/O portion 130. An analog baseband video signal processed by the controller 170 may be transmitted to the display 180, and may then be displayed by the display 180. On the other hand, an analog baseband audio signal processed by the controller 170 may be transmitted to the audio output portion 185 (e.g., a speaker) and may then be output through the audio output portion 185.

The image display apparatus 100 may also include a channel-browsing processor (not shown) which generates a thumbnail image corresponding to a channel signal or an externally-input signal. The channel-browsing processor may receive the stream signal TS from the demodulator 120 or the external signal I/O portion 130, may extract an image from the stream signal TS, and may generate a thumbnail image based on the extracted image. The thumbnail image generated by the channel-browsing processor may be transmitted to the controller 170 as it is without being encoded. Alternatively, the thumbnail image generated by the channel-browsing processor may be encoded, and the encoded thumbnail image may be transmitted to the controller 170. The controller 170 may display a thumbnail list including a number of thumbnail images input thereto on the display 180.

The controller 170 may receive a signal from the remote control device 200 via the interface 150. Thereafter, the controller 170 may identify a command input to the remote control device 200 by a user based on the received signal, and may control the image display apparatus 100 in accordance with the identified command. For example, if a user inputs a command to select a predetermined channel, the controller 170 may control the tuner 110 to receive a video signal, an audio signal and/or a data signal from the predetermined channel, and may process the signal(s) received by the tuner 110. Thereafter, the controller 170 may control channel information regarding the predetermined channel to be output through the display 180 or the audio output portion 185 along with the processed signal(s).

A user may input a command to display various types of A/V signals to the image display apparatus 100. If a user wishes to watch a camera or camcorder image signal received by the external signal I/O portion 130, instead of a broadcast signal, the controller 170 may control a video signal or an audio signal to be output via the display 180 or the audio output portion 185.

The controller 170 may identify a user command input to the image display apparatus 100 via a number of local keys, which is included in the sensing portion, and may control the image display apparatus 100 in accordance with the identified user command. For example, a user may input various commands such as a command to turn on or off the image display apparatus 100, a command to switch channels, or a command to change volume to the image display apparatus 100 using the local keys. The local keys may include buttons or keys provided at the image display apparatus 100. The controller 170 may determine how the local keys have been manipulated by a user, and may control the image display apparatus 100 according to the results of the determination.

The display 180 may convert a processed video signal, a processed data signal, and an OSD signal provided by the controller 170 or a video signal and a data signal provided by the external signal I/O portion 130 into RGB signals, thereby generating driving signals. The display 180 may be implemented into various types of displays such as a plasma display panel, a liquid crystal display (LCD), an organic light-emitting diode (OLED), and a flexible display. Specially, the display 180 may be implemented into a three-dimensional (3D) display.

The display 180 may be classified into an additional display or an independent display. The independent display is a display device capable of displaying a 3D image without a requirement of additional display equipment such as glasses. Examples of the independent display include a lenticular display and parallax barrier display. On the other hand, the additional display is a display device capable of displaying a 3D image with the aid of additional display equipment. Examples of the additional display include a head mounted display (HMD) and an eyewear display (such as a polarized glass-type display, a shutter glass display, or a spectrum filter-type display).

The display 180 may also be implemented as a touch screen and may thus be used not only as an output device but also as an input device.

The audio output portion 185 may receive a processed audio signal (e.g., a stereo signal, a 3.1-channel signal or a 5.1-channel signal) from the controller 170 and may output the received audio signal. The audio output portion 185 may be implemented into various types of speakers.

The remote control device 200 may transmit a user input to the interface 150. For this, the remote control device 200 may use various communication techniques such as Bluetooth, RF, IR, UWB and ZigBee.

The remote control device 100 may receive a video signal, an audio signal or a data signal from the interface 150, and may output the received signal.

The image display apparatus 100 may also include the sensing portion. The sensing portion may include a touch sensor, an acoustic sensor, or a position sensor.

The touch sensor may be a touch screen of the display 180. The touch sensor may sense where on the touch screen and with what intensity a user is touching. The acoustic sensor may sense the voice of a user various sounds generated by a user. The position sensor may sense the position of a user. The motion sensor may sense a gesture generated by a user. The position sensor or the motion sensor may include an infrared detection sensor or camera, and may sense the distance between the image display apparatus 100 and a user, and any hand gestures made by the user.

The sensing portion may transmit various sensing results provided by the touch sensor, the acoustic sensor, the position sensor and the motion sensor to a sensing signal processor (not shown). Alternatively, the sensing portion may analyze the various sensing results, and may generate a sensing signal based on the results of the analysis. Thereafter, the sensing portion may provide the sensing signal to the controller 170.

The sensing signal processor may process the sensing signal provided by the sensing portion, and may transmit the processed sensing signal to the controller 170.

The image display apparatus 100 may be a fixed digital broadcast receiver capable of receiving at least one of ATSC (8-VSB) broadcast programs, DVB-T (COFDM) broadcast programs, and ISDB-T (BST-OFDM) broadcast programs or may be a mobile digital broadcast receiver capable of receiving at least one of terrestrial DMB broadcast programs, satellite DMB broadcast programs, ATSC-M/H broadcast programs, DVB-H (COFDM) broadcast programs, and Media Forward Link Only (MediaFLO) broadcast programs. Alternatively, the image display apparatus 100 may be a digital broadcast receiver capable of receiving cable broadcast programs, satellite broadcast programs or IPTV programs.

Examples of the image display apparatus 100 include a TV receiver, a mobile phone, a smart phone, a laptop computer, a digital broadcast receiver, a personal digital assistant (PDA) and a portable multimedia player (PMP).

The structure of the image display apparatus 100 shown in FIG. 1 is exemplary. The elements of the image display apparatus 100 may be incorporated into fewer modules, new elements may be added to the image display apparatus 100 or some of the elements of the image display apparatus 100 may not be provided. That is, two or more of the elements of the image display apparatus 100 may be incorporated into a single module, or some of the elements of the image display apparatus 100 may each be divided into two or more smaller portions. The functions of the elements of the image display apparatus 100 are also exemplary, and thus do not put any restrictions on the scope of the present invention.

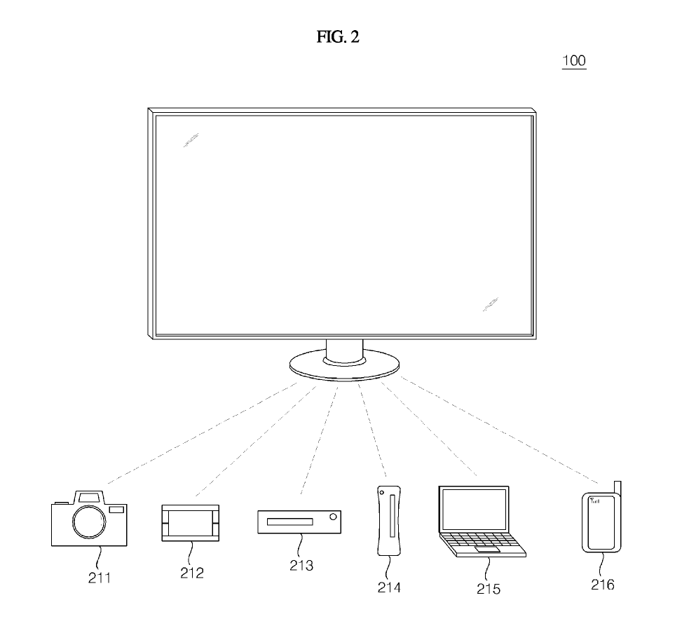

FIG. 2 illustrates examples of an external device that can be physically ore wirelessly connected to the image display apparatus 100. Referring to FIG. 3, the image display apparatus 100 may be connected either wiredly or wirelessly to an external device via the external signal I/O portion 130.

Examples of the external device to which the image display apparatus 100 may be connected include a camera 211, a screen-type remote control device 212, a set-top box 213, a game console 214, a computer 215 and a mobile communication terminal 216.

When connected to an external device via the external signal I/O portion 130, the image display apparatus 100 may display a graphic user interface (GUI) screen provided by the external device on the display 180. Then, a user may access both the external device and the image display apparatus 100 and may thus be able to view video data currently being played by the external device or video data present in the external device from the image display apparatus 100. In addition, the image display apparatus 100 may output audio data currently being played by the external device or audio data present in the external device via the audio output portion 185.

Various data, for example, still image files, moving image files, music files or text files, present in an external device to which the image display apparatus 100 is connected via the external signal I/O portion 130 may be stored in the storage 140 of the image display apparatus 100. In this case, even after disconnected from the external device, the image display apparatus 100 can output the various data stored in the storage 140 via the display 180 or the audio output portion 185.

When connected to the mobile communication terminal 216 or a communication network via the external signal I/O portion 130, the image display apparatus 100 may display a screen for providing a video or voice call service on the display 180 or may output audio data associated with the provision of the video or voice call service via the audio output portion 185. Thus, a user may be allowed to make or receive a video or voice call with the image display apparatus 100, which is connected to the mobile communication terminal 216 or a communication network.

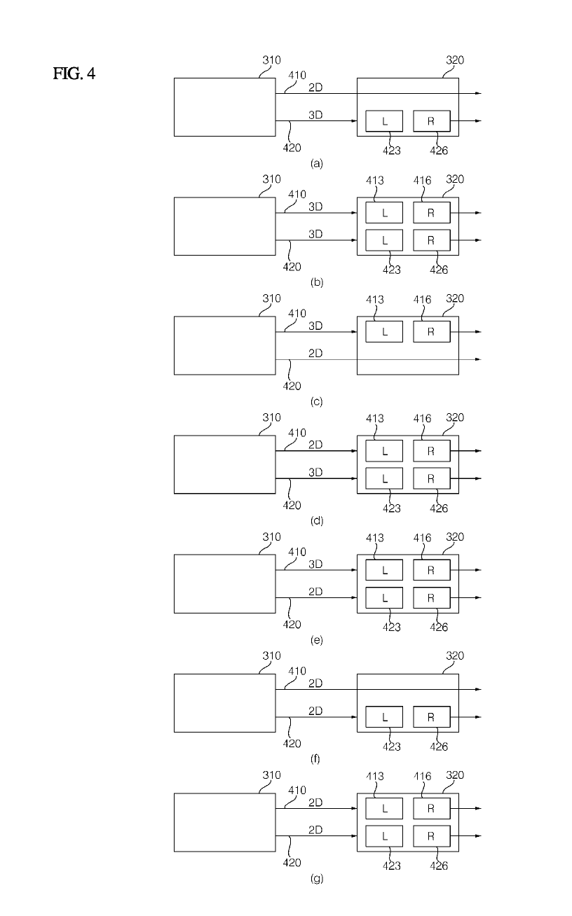

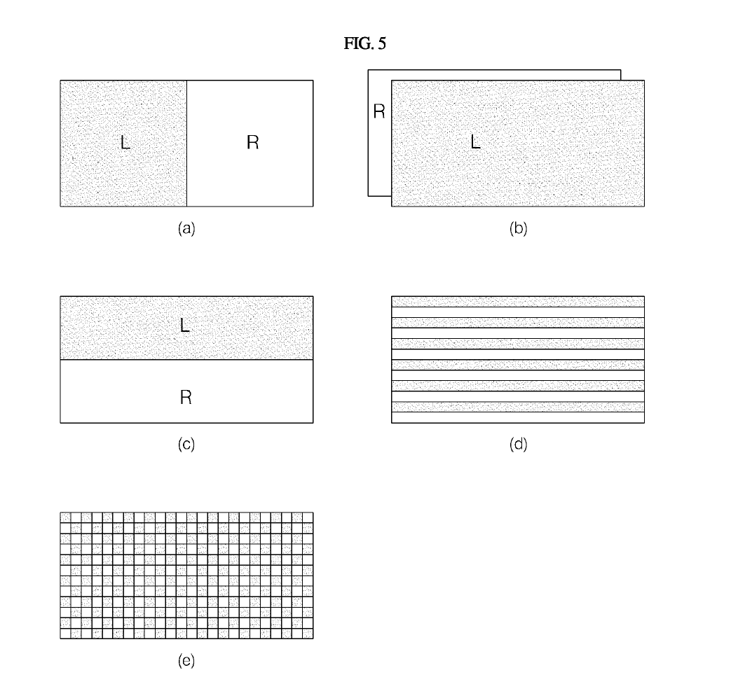

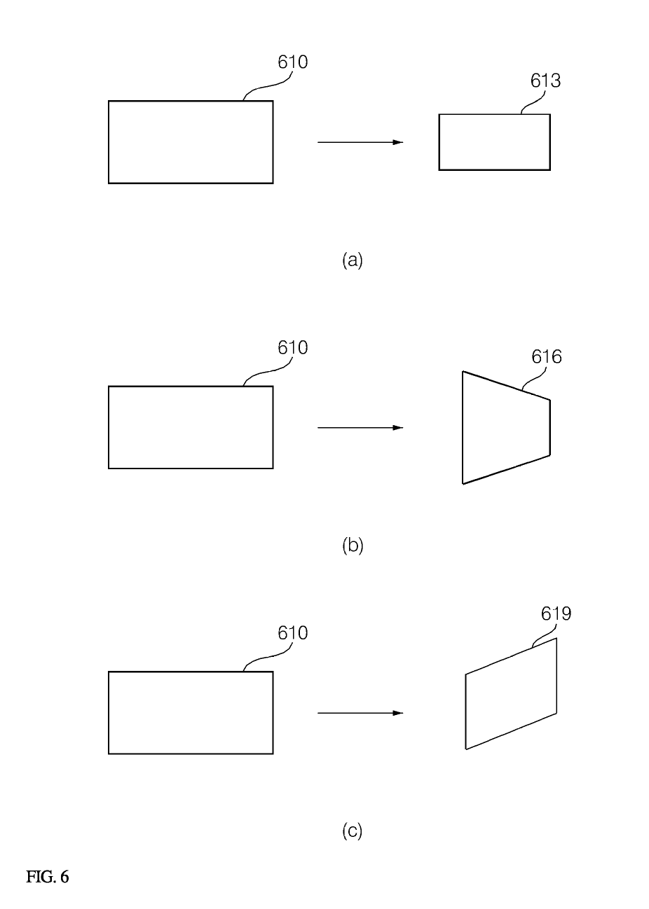

FIGS. 3(a) and 3(b) illustrate block diagrams of the controller 170, FIGS. 4(a) through 4(g) illustrate how a formatter 320 shown in FIG. 3(a) or 3(b) separates a 2-dimensional (2D) image signal and a 3-dimensional (3D) image signal, FIGS. 5(a) through 5(e) illustrate various examples of the format of a 3D image output by the formatter 320, and FIGS. 6(a) through 6(c) illustrate how to scale a 3D image output by the formatter 320.

Referring to FIG. 3(a), the controller 170 may include an image processor 310, the formatter 320, an on-screen display (OSD) generator 330 and a mixer 340.

Referring to FIG. 3(a), the image processor 310 may decode an input image signal, and may provide the decoded image signal to the formatter 320. Then, the formatter 320 may process the decoded image signal provided by the image processor 310 and may thus provide a plurality of view image signals. The mixer 340 may mix the plurality of view image signals provided by the formatter 320 and an image signal provided by the OSD generator 330.

More specifically, the image processor 310 may process both a broadcast signal processed by the tuner 110 and the demodulator 120 and an externally input signal provided by the external signal I/O portion 130.

The input image signal may be a signal obtained by demultiplexing a stream signal.

If the input image signal is, for example, an MPEG-2-encoded 2D image signal, the input image signal may be decoded by an MPEG-2 decoder.

On the other hand, if the input image signal is, for example, an H.264-encoded 2D image signal according to DMB or DVB-H, the input image signal may be decoded by an H.264 decoder.

On the other hand, if the input image signal is, for example, an MPEG-C part 3 image with disparity information and depth information, not only the input image signal but also the disparity information and depth information may be decoded by an MPEG-C decoder.

On the other hand, if the input image signal is, for example, a Multi-View Video Coding (MVC) image, the input image signal may be decoded by an MVC decoder.

On the other hand, if the input image signal is, for example, a free viewpoint TV (FTV) image, the input image signal may be decoded by an FTV decoder.

The decoded image signal provided by the image processor 310 may include a 2D image signal only, include both a 2D image signal and a 3D image signal or include a 3D image signal only.

The decoded image signal provided by the image processor 310 may be a 3D image signal with various formats. For example, the decoded image signal provided by the image processor 310 may be a 3D image including a color image and a depth image or a 3D image including a plurality of image signals. The plurality of image signals may include a left-eye image signal L and a right-eye image signal R. The left-eye image signal L and the right-eye image signal R may be arranged in various formats such as a side-by-side format shown in FIG. 5(a), a frame sequential format shown in FIG. 5(b), a top-down format shown in FIG. 5(c), an interlaced format shown in FIG. 5(d), or a checker box format shown in FIG. 5(e).

If the input image signal includes caption data or an image signal associated with data broadcasting, the image processor 310 may separate the caption data or the image signal associated with data broadcasting from the input image signal and may output the caption data or the image signal associated with data broadcasting to the OSD generator 330. Then, the OSD generator 330 may generate 3D objects based on the caption data or the image signal associated with data broadcasting.

The formatter 320 may receive the decoded image signal provided by the image processor 310, and may separate a 2D image signal and a 3D image signal from the received decoded image signal. The formatter 320 may divide a 3D image signal into a plurality of view signals, for example, a left-eye image signal and a right-eye image signal.

It may be determined whether the decoded image signal provided by the image processor 310 is a 2D image signal or a 3D image signal based on whether a 3D image flag, 3D image metadata, or 3D image format information is included in the header of a corresponding stream.

The 3D image flag, the 3D image metadata or the 3D image format information may include not only information regarding a 3D image but also location information, region information or size information of the 3D image. The 3D image flag, the 3D image metadata or the 3D image format information may be decoded, and the decoded 3D image flag, the decoded image metadata or the decoded 3D image format information may be transmitted to the formatter 320 during the demultiplexing of the corresponding stream.

The formatter 320 may separate a 3D image signal from the decoded image signal provided by the image processor 310 based on the 3D image flag, the 3D image metadata or the 3D image format information. The formatter 320 may divide the 3D image signal into a plurality of image signals with reference to the 3D image format information. For example, the formatter 320 may divide the 3D image signal into a left-eye image signal and a right-eye image signal based on the 3D image format information.

Referring to FIGS. 4(a) through 4(g), the formatter 320 may separate a 2D image signal and a 3D image signal from the decoded image signal provided by the image processor 310 and may then divide the 3D image signal into a left-eye image signal and a right-eye image signal.

More specifically, referring to FIG. 4(a), if a first image signal 410 is a 2D image signal and a second image signal 420 is a 3D image signal, the formatter 320 may separate the first and second image signals 410 and 420 from each other, and may divide the second image signal 420 into a left-eye image signal 423 and a right-eye image signal 426. The first image signal 410 may correspond to a main image to be displayed on the display 180, and the second image signal 420 may correspond to a picture-in-picture (PIP) image to be displayed on the display 180.

Referring to FIG. 4(b), if the first and second image signals 410 and 420 are both 3D image signals, the formatter 320 may separate the first and second image signals 410 and 420 from each other, may divide the first image signal 410 into a left-eye image signal 413 and a right-eye image signal 416, and may divide the second image signal 420 into the left-eye image signal 423 and the right-eye image signal 426.

Referring to FIG. 4(c), if the first image signal 410 is a 3D image signal and the second image signal 420 is a 2D image signal, the formatter 320 may divide the first image signal into the left-eye image signal 413 and the right-eye image signal 416.

Referring to FIGS. 4(d) and 4(e), if one of the first and second image signals 410 and 420 is a 3D image signal and the other image signal is a 2D image signal, the formatter 320 may convert whichever of the first and second image signals 410 and 420 is a 2D image signal into a 3D image signal in response to, for example, user input. More specifically, the formatter 320 may convert a 2D image signal into a 3D image signal by detecting edges from the 2D image signal using a 3D image creation algorithm, extracting an object with the detected edges from the 2D image signal, and generating a 3D image signal based on the extracted object. Alternatively, the formatter 320 may convert a 2D image signal into a 3D image signal by detecting an object, if any, from the 2D image signal using a 3D image process algorithm and generating a 3D image signal based on the detected object. Once a 2D image signal is converted into a 3D image signal, the formatter 320 may divide the 3D image signal into a left-eye image signal and a right-eye image signal. A 2D image signal except for an object to be reconstructed as a 3D image signal may be output as a 2D image signal.

Referring to FIG. 4(f), if the first and second image signals 410 and 420 are both 2D image signals, the formatter 320 may convert only one of the first and second image signals 410 and 420 into a 3D image signal using a 3D image process algorithm. Alternatively, referring to FIG. 4G, the formatter 320 may convert both the first and second image signals 410 and 420 into 3D image signals using a 3D image process algorithm.

If there is a 3D image flag, 3D image metadata or 3D image format information available, the formatter 320 may determine whether the decoded image signal provided by the image processor 310 is a 3D image signal with reference to the 3D image flag, the 3D image metadata or the 3D image format information. On the other hand, if there is no 3D image flag, 3D image metadata or 3D image format information available, the formatter 320 may determine whether the decoded image signal provided by the image processor 310 is a 3D image signal by using a 3D image process algorithm.

A 3D image signal provided by the image processor 310 may be divided into a left-eye image signal and a right-eye image signal by the formatter 320. Thereafter, the left-eye image signal and the right-eye image signal may be output in one of the formats shown in FIGS. 5(a) through 5(e). A 2D image signal provided by the image processor 310, however, may be output as is without the need to be processed or may be transformed and thus output as a 3D image signal.

As described above, the formatter 320 may output a 3D image signal in various formats. More specifically, referring to FIGS. 5(a) through 5(e), the formatter 320 may output a 3D image signal in a side-by-side format, a frame sequential format, a top-down format, an interlaced format, in which a left-eye image signal and a right-eye image signal are mixed on a line-by-line basis, or a checker box format, in which a left-eye image signal and a right-eye image signal are mixed on a box-by-box basis.

A user may select one of the formats shown in FIGS. 5(a) through 5(e) as an output format for a 3D image signal. For example, if a user selects the top-down format, the formatter 320 may reconfigure a 3D image signal input thereto, divide the input 3D image signal into a left-eye image signal and a right-eye image signal, and output the left-eye image signal and the right-eye image signal in the top-down format regardless of the original format of the input 3D image signal.

A 3D image signal input to the formatter 320 may be a broadcast image signal, an externally-input signal or a plurality of view image signal with a predetermined depth. The formatter 320 may divide the 3D image signal into a left-eye view image signal and a right-eye image signal.

Left-eye image signals or right-eye image signals extracted from 3D image signals having different depths may differ from one another. That is, a left-eye image signal or a right-eye image signal extracted from a 3D image signal may change according to the depth of the 3D image signal.

If the depth of a 3D image signal is changed in accordance with a user input or user settings, the formatter 320 may divide the 3D image signal into a left-eye image signal and a right-eye image signal in consideration of the changed depth.

The formatter 320 may scale a 3D image signal, and particularly, a 3D object in a 3D image signal, in various manners.

More specifically, referring to FIG. 6(a), the formatter 320 may generally enlarge or reduce a 3D image signal or a 3D object in the 3D image signal. Alternatively, referring to FIG. 6(b), the formatter 320 may partially enlarge or reduce the 3D image signal or the 3D object into a trapezoid. Alternatively, referring to FIG. 6(c), the formatter 320 may rotate the 3D image signal or the 3D object and thus transform the 3D object or the 3D object into a parallelogram. In this manner, the formatter 320 may add a sense of three-dimensionality to the 3D image signal or the 3D object and may thus emphasize a 3D effect. The 3D image signal may be a left-eye image signal or a right-eye image signal of the second image signal 420. Alternatively, the 3D image signal may be a left-eye image signal or a right-eye image signal of a PIP image.

In short, the formatter 320 may receive the decoded image signal provided by the image processor 310, may separate a 2D image signal or a 3D image signal from the received image signal, and may divide the 3D image signal into a left-eye image signal and a right-eye image signal. Thereafter, the formatter 320 may scale the left-eye image signal and the right-eye image signal and may then output the results of the scaling in one of the formats shown in FIGS. 5(a) through 5(e). Alternatively, the formatter 320 may rearrange the left-eye image signal and the right-eye image signal in one of the formats shown in FIGS. 5(a) through 5(e) and may then scale the result of the rearrangement.

Referring to FIG. 3(a), the OSD generator 330 may generate an OSD signal in response to or without user input. The OSD signal may include a 2D OSD object or a 3D OSD object.

It may be determined whether the OSD signal includes a 2D OSD object or a 3D OSD object based on user input, the size of the object or whether the OSD object of the OSD signal is an object that can be selected.

The OSD generator 330 may generate a 2D OSD object or a 3D OSD object and output the generated OSD object, whereas the formatter 320 merely processes the decoded image signal provided by the image processor 310. A 3D OSD object may be scaled in various manners, as shown in FIGS. 6(a) through 6(c). The type or shape of a 3D OSD object may vary according to the depth at which the 3D OSD is displayed.

The OSD signal may be output in one of the formats shown in FIGS. 5(a) through 5(e). More specifically, the OSD signal may be output in the same format as that of an image signal output by the formatter 320. For example, if a user selects the top-down format as an output format for the formatter 320, the top-down format may be automatically determined as an output format for the OSD generator 330.

The OSD generator 330 may receive a caption- or data broadcasting-related image signal from the image processor 310, and may output a caption- or data broadcasting-related OSD signal. The caption- or data broadcasting-related OSD signal may include a 2D OSD object or a 3D OSD object.

The mixer 340 may mix an image signal output by the formatter 320 with an OSD signal output by the OSD generator 330, and may output an image signal obtained by the mixing. The image signal output by the mixer 340 may be transmitted to the display 180.

The controller 170 may have a structure shown in FIG. 3(b). Referring to FIG. 3(b), the controller 170 may include an image processor 310, a formatter 320, an OSD generator 330 and a mixer 340. The image processor 310, the formatter 320, the OSD generator 330 and the mixer 340 are almost the same as their respective counterparts shown in FIG. 3(a), and thus will hereinafter be described, focusing mainly on differences with their respective counterparts shown in FIG. 3(a).

Referring to FIG. 3(b), the mixer 340 may mix a decoded image signal provided with the image processor 310 with an OSD signal provided by the OSD generator 330, and then, the formatter 320 may process an image signal obtained by the mixing performed by the mixer 340. Thus, the OSD generator 330 shown in FIG. 3(b), unlike the OSD generator 330 shown in FIG. 3(a), does no need to generate a 3D object. Instead, the OSD generator 330 may simply generate an OSD signal corresponding to any given 3D object.

Referring to FIG. 3(b), the formatter 320 may receive the image signal provided by the mixer 340, may separate a 3D image signal from the received image signal, and may divide the 3D image signal into a plurality of image signals. For example, the formatter 320 may divide a 3D image signal into a left-eye image signal and a right-eye image signal, may scale the left-eye image signal and the right-eye image signal, and may output the scaled left-eye image signal and the scaled right-eye image signal in one of the formats shown in FIGS. 5(a) through 5(e).

The structure of the controller 170 shown in FIG. 3(a) or 3(b) is exemplary. The elements of the controller 170 may be incorporated into fewer modules, new elements may be added to the controller 170 or some of the elements of the controller 170 may not be provided. That is, two or more of the elements of the controller 170 may be incorporated into a single module, or some of the elements of the controller 170 may each be divided into two or more smaller portions. The functions of the elements of the controller 170 are also exemplary, and thus do not put any restrictions on the scope of the present invention.

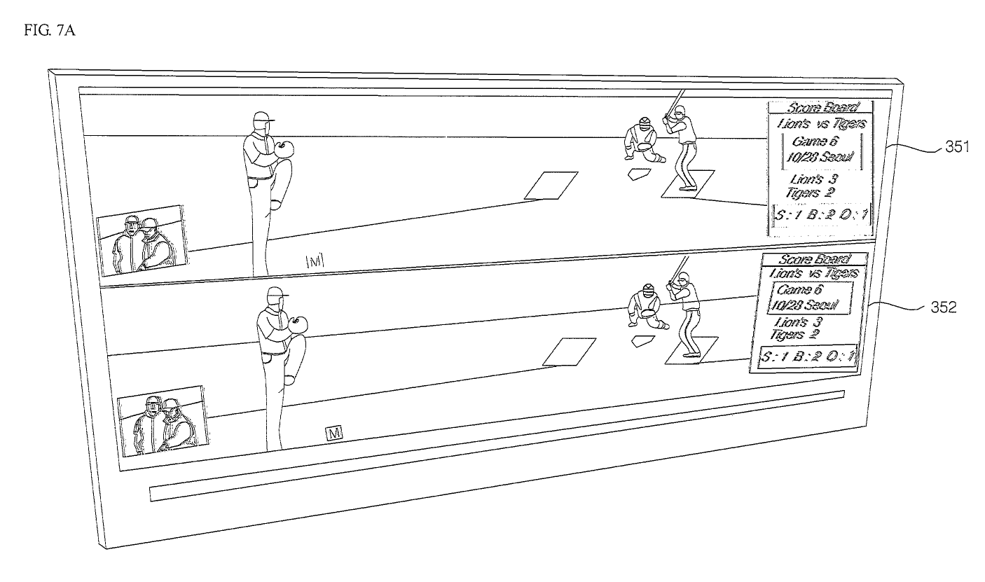

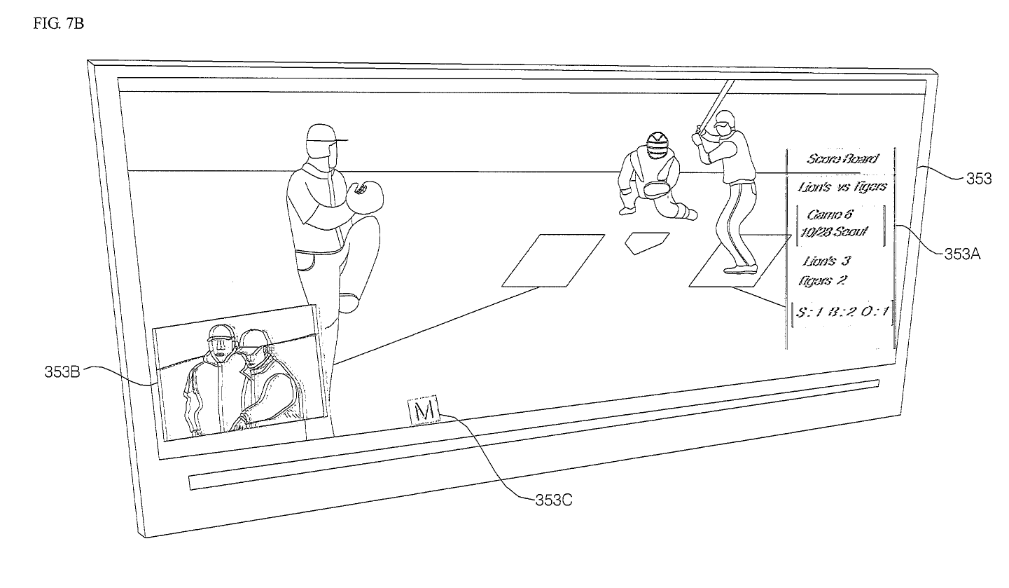

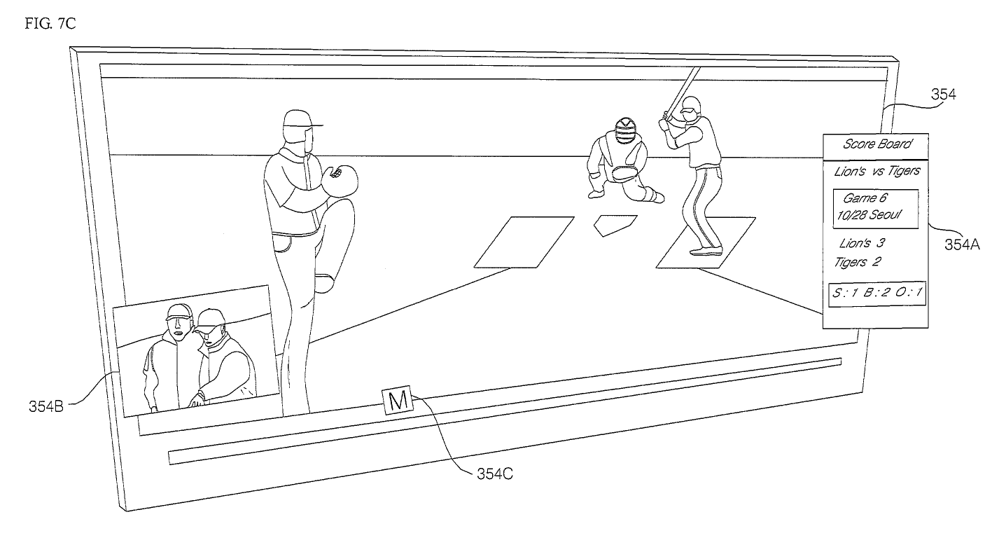

FIGS. 7A through 7C illustrate various images that can be displayed by the image display apparatus 100. Referring to FIGS. 7A through 7C, the image display apparatus 100 may display a 3D image in one of the formats shown in FIGS. 5(a) through 5(e), e.g., the top-down format.

More specifically, referring to FIG. 7A, when the play of video data is terminated, the image display apparatus 100 may display two images 351 and 352 in the top-down format so that the two images 351 and 352 can be arranged side by side vertically on the display 180.

The image display apparatus 100 may display a 3D image on the display 180 using a method that requires the use of polarized glasses to properly view the 3D image. In this case, when viewed without polarized glasses, the 3D image and 3D objects in the 3D image may not appear in focus, as indicated by reference numerals 353 and 353A through 353C.

On the other hand, when viewed with polarized glasses, not only the 3D image but also the 3D objects in the 3D image may appear in focus, as indicated by reference numerals 354 and 354A through 354C. The 3D objects in the 3D image may be displayed as if protruding beyond the 3D image.

If the image display apparatus 100 displays a 3D image using a method that does not require the use of polarized glasses to properly view the 3D image, the 3D image and 3D objects in the 3D image may all appear in focus even when viewed without polarized glasses, as shown in FIG. 7C.

The term ‘object,’ as used herein, includes various information regarding the image display apparatus 100 such as audio output level information, channel information, or current time information and an image or text displayed by the image display apparatus 100.

For example, a volume control button, a channel button, a control menu, an icon, a navigation tab, a scroll bar, a progressive bar, a text box and a window that can be displayed on the display 180 of the image display apparatus 100 may be classified as objects.

A user may acquire information regarding the image display apparatus 100 or information regarding an image displayed by the image display apparatus 100 from various objects displayed by the image display apparatus 100. In addition, a user may input various commands to the image display apparatus 100 through various objects displayed by the image display apparatus 100.

When a 3D object has as positive depth, it may be displayed as if protruding toward a user. The depth on the display module 180 or the depth of a 2D image or a 3D image displayed on the display 180 may be set to 0. When a 3D object has a negative depth, it may be displayed as if recessed into the display 180. As a result, the greater the depth of a 3D object is, the more the 3D object appears protruding toward a user.

The term ‘3D object,’ as used herein, includes various objects generated through, for example, a scaling operation, which has already been described above with reference to FIGS. 6(a) through 6(c), so as to create a sense of three-dimensionality or the illusion of depth.

FIG. 7C illustrates a PIP image as an example of a 3D object, but the present invention is not restricted to this. That is, electronic program guide (EPG) data, various menus provided by the image display apparatus 100, widgets or icons may also be classified as 3D objects.

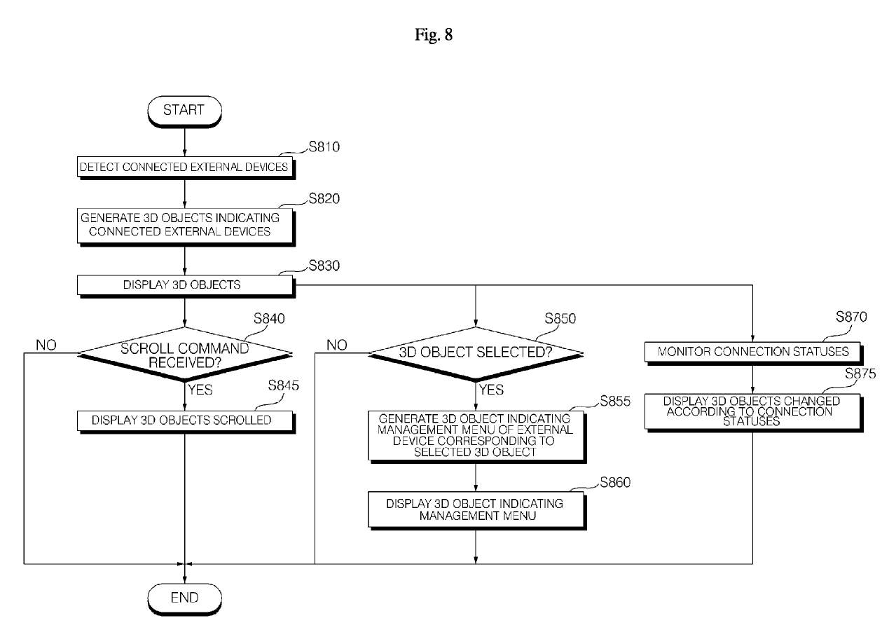

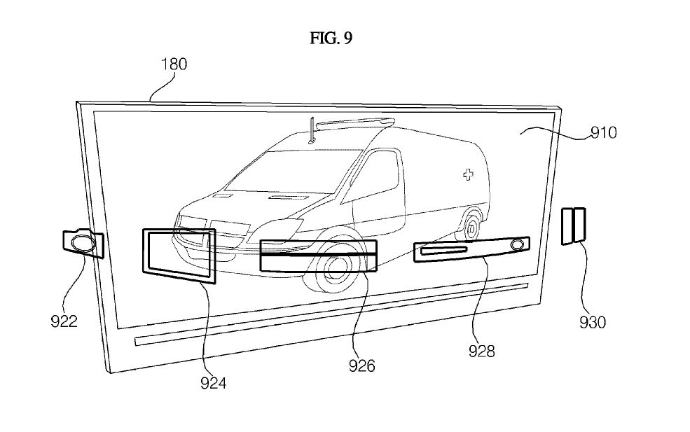

FIG. 8 is a flowchart illustrating a method for operating the image display apparatus according to an exemplary embodiment of the present invention.

Referring to FIG. 8, connected external devices are detected in step S810.

The image display apparatus may be connected to external devices wirelessly or wiredly through the external signal I/O portion 130 illustrated in FIG. 1.

Specifically, the controller 170 may determine whether the image display apparatus 100 has been connected to an external device based on the amount of data transmitted to and received from the external device, the strength of a signal received from the external device, or power supplied to the external device (e.g. USB power 5V).

3D objects representing the connected external devices are generated in step S820.

The controller 170, particularly the OSD generator 330 may generate the 3D objects representing the connected external devices.

The 3D objects may have a different depth from the display 180 or an image displayed on the display 180. The image displayed on the display 180 may be a 2D or 3D image, and it is preferable to set the depth of the 3D objects representing the connected external devices to be different from the depth of the 2D or 3D image. In this manner, the user can intuitively recognize the connected external devices.

The OSD generator 330 may process the 3D objects in such a manner that as the 3D objects are deeper, the disparity between their left-eye and right-eye 3D objects is narrowed.

The left-eye and right-eye 3D objects may be output in one of the formats illustrated in FIG. 5.

In step S830, the 3D objects are displayed under the control of the controller 170. Since the 3D objects were processed to have a different depth from the image displayed on the display 180, for example, a positive depth, the 3D objects are displayed, giving the illusion of 3D. Among the afore-described display schemes, a glass-type display scheme makes the 3D objects appear protruding to the user, when the user wears 3D glasses.

When a scroll command is issued in step S840, the 3D objects are scrolled in step S845.

For example, when a motion sensing portion (not shown) senses a user gesture or when an input, for example, a directional key input is received from the remote control device 200, the controller 187 may scroll or rotate the 3D objects on the display 180 according to the user gesture or the input from the remote control device 200. The controller 170, particularly the OSD generator 330 may process the 3D objects so that the 3D objects are displayed shifted based on the input operation. Thus, the user can easily select a desired 3D object.

When a 3D object selection command is received in step S850, a 3D object representing a management menu of the external device corresponding to a selected 3D image is generated in step S855 and displayed in step S860.

For example, if a 3D object is selected by a user gesture sensed by the sensing portion or an input from the remote control device 200, the controller 170 generates a 3D object representing a management menu of the external device corresponding to the selected 3D object. The management menu may have a different depth from the image displayed on the display 180.

In the case where the management menu is configured as a pull-down menu, the 3D object representing the management menu may be as deep as the 3D objects representing the connected external devices.

In the case where the management menu is configured as a pop-up menu, the 3D object representing the management menu may be deeper than the 3D objects representing the connected external devices. That is, the 3D object representing the management menu may look more protruding than the 3D objects representing the connected external devices.

The displaying of the 3D object representing the management menu enables the user to select many menus of the selected external device, thus increasing user convenience.

Besides a 3D object, the management menu may be displayed as a 2D object. This 2D object may be displayed on the display 180.

In addition, the management menu and the 3D object representing the external device may be selectively displayed. For example, the object representing the management menu may appear in place of the 3D object representing the external device that is disappearing, in a sliding manner.

In step S870, the connection statuses of the external devices are monitored. The 3D objects representing the external devices are displayed changed according to the connection statuses in step S875.

The controller 170 may determine the connection statuses of the external devices based on the signal strengths or data amounts of the external devices. Especially, the 3D objects representing the external devices may be displayed changed according to radio environments.

For example, a 3D object representing an external device may be displayed with a change in at least one of size, brightness, transparency, color, and shaking, according to the connection status of the external device. A 3D object representing a well-connected external device may be displayed brighter, whereas a 3D object representing a poorly-connected external device may be displayed less bright or shaken. Therefore, the user can intuitively identify the connection statuses of the external devices.

The operation method illustrated in FIG. 8 may further include the step (not shown) of displaying a 3D object changed, when the external device corresponding to the 3D object is disconnected. As stated above, the 3D object representing the external device may be changed in at least one of size, brightness, transparency, color, and shaking.

It is also possible to display 3D objects representing unconnected external devices along with the 3D objects representing the connected external devices. The former may differ from the latter in at least one of depth, size, brightness, transparency, color, and shaking.

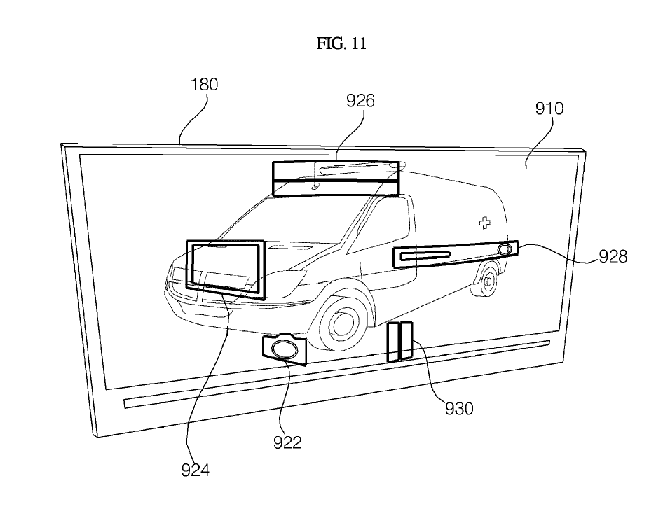

The 3D objects representing the connected and unconnected external devices may be arranged in the pattern of a fish eye as illustrated in FIG. 9 or a circle as illustrated in FIG. 11. Many other patterns are available to the 3D object arrangement.

FIGS. 9 to 18 are views referred to for describing various examples of the method for operating the image display apparatus, illustrated in FIG. 8.

In FIG. 9, 3D objects representing connected external devices are displayed with the illusion of 3D. The external devices may include a camera, a Portable Multimedia Player (PMP), a set-top box, a DVD player, and a game console, as illustrated in FIG. 9.

Referring to FIG. 9, a camera, a PMP, a set-top box, a DVD player, and a game console are all connected to the image display apparatus 100 and thus 3D objects 922, 924, 926, 928 and 930 representing the connected external devices are displayed over an image 910 on the display 180.

The image 910 is different in depth from the 3D objects 922, 924, 926, 928 and 930. The 3D objects 922, 924, 926, 928 and 930 may look protruding to different degrees according to their depths.

As in FIG. 9, the 3D object 926 representing the set-top box may be the deepest of the 3D objects 922, 924, 926, 928 and 930. Aside from the 3D object 926, the 3D objects 924 and 928 representing the PMP and the DVD player, respectively may be deeper than the 3D objects 922 and 930 representing the camera and the game console, respectively.

While it is shown that the 3D objects 924 and 928 are equal in depth and the 3D objects 922 and 930 are equal in depth in FIG. 9, the 3D objects 922, 924, 926, 928 and 930 may be different in depth.

For example, among a plurality of 3D objects, a 3D object representing a latest connected external device, a 3D object representing an external device that ranks highest in connection frequency or connection duration, or a 3D object representing a new connected external device may be set to be deeper than another 3D object, so that the 3D object appears nearest to the user, that is, most protruding. Therefore the user can intuitively identify the external device corresponding to the 3D object.

The 3D objects 922, 924, 926, 928 and 930 may have different depths according to one of connection frequency, connection order, and connection duration. When the 3D objects 922, 924, 926, 928 and 930 are at different depths corresponding to their connection frequencies, connection order or connection durations, the user can easily access them in the order of their connection frequencies, connection turns, or connection durations.

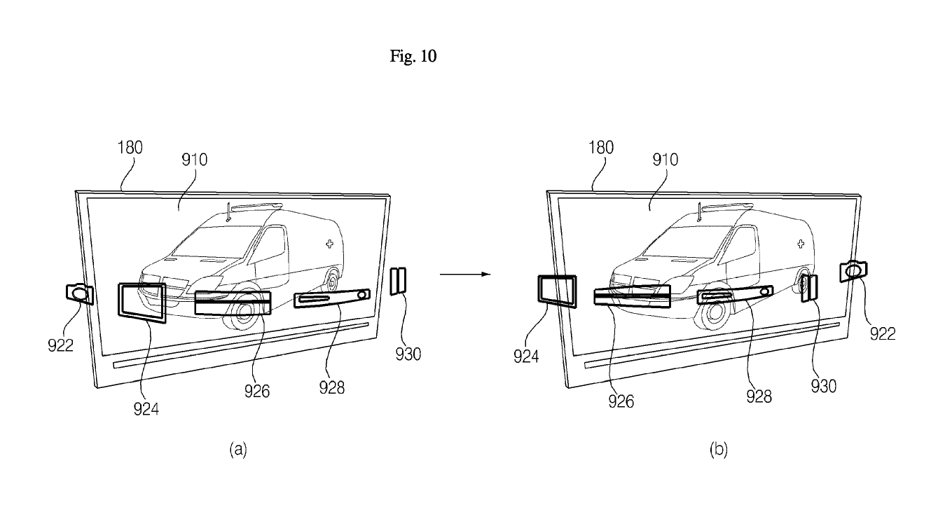

FIG. 10 illustrates left scrolling or rotation of the 3D objects 922, 924, 926, 928 and 930, over the image 910 displayed on the display 180. Besides the direction illustrated in FIG. 10, the 3D objects 922, 924, 926, 928 and 930 may be moved in many other directions. All of the 3D objects 922, 924, 926, 928 and 930 may be shifted in the same direction, to which the present invention is not limited. Also, only one of the 3D objects 922, 924, 926, 928 and 930 may be moved. In addition, the 3D objects 922, 924, 926, 928 and 930 may be rotated three-dimensionally.

FIG. 11 illustrates displaying of the 3D objects 922, 924, 926, 928 and 930 at the same depth in a circle over the image 910 on the display 180. The same depth means the same protrusion degree. Notably, the image 910 has a different depth from the 3D objects 922, 924, 926, 928 and 930.

The 3D objects 922, 924, 926, 928 and 930 may be displayed at different display coordinates. Display coordinates may correspond to (x, y) coordinates on the display 180. Depth is set along a z axis. Hence, the 3D objects 922, 924, 926, 928 and 930 have different (x, y) coordinates with the same depth along the z axis.

Many patterns other than a circle are available in arranging the 3D objects 922, 924, 926, 928 and 930. To avoid the user's distraction from the image 910, the 3D objects 922, 924, 926, 928 and 930 may be positioned in the vicinity of a corner of the display 180.

Besides the fish eye pattern illustrated in FIG. 9 and the circle pattern illustrated in FIG. 11, the 3D objects 922, 924, 926, 928 and 930 may be displayed in a polyhedron pattern such as a cube.

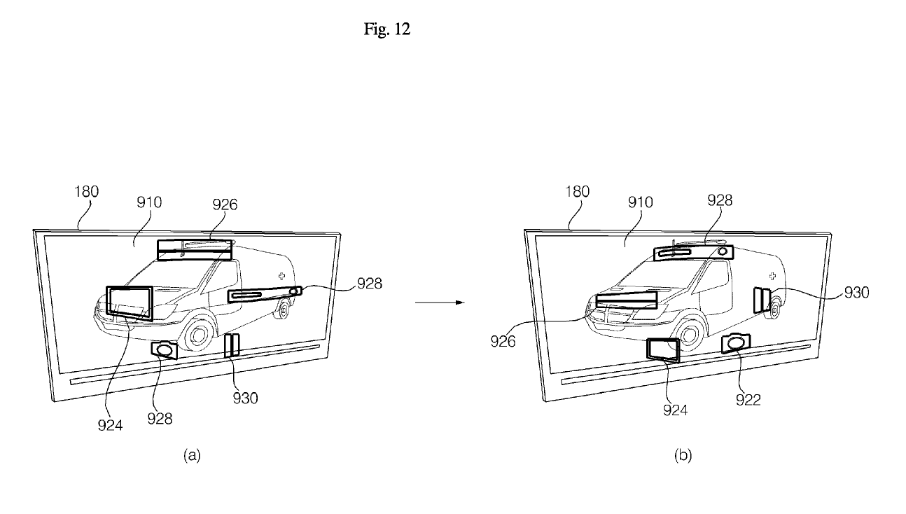

FIG. 12 illustrates counterclockwise rotation of the 3D objects 922, 924, 926, 928 and 930 arranged in the circle, over the image 910 on the display 180. The 3D objects 922, 924, 926, 928 and 930 may move in any other direction than illustrated in FIG. 12.

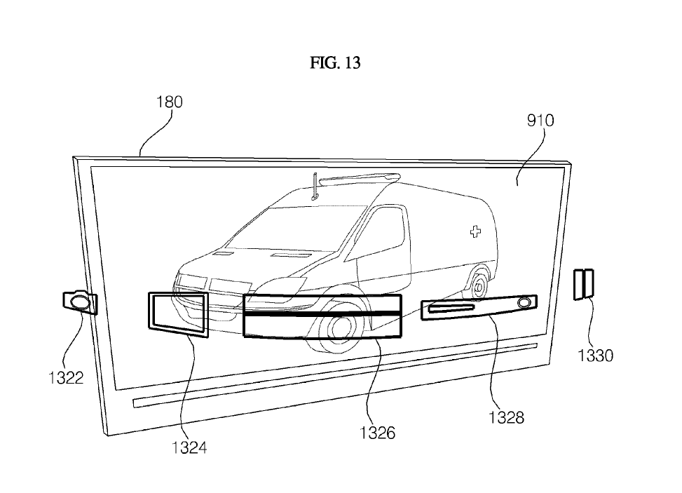

FIG. 13 illustrates displaying of 3D objects 1322, 1324, 1326, 1328 and 1330 in different sizes over the image 910 on the display 180. The image 910 has a different depth from the 3D objects 1322, 1324, 1326, 1328 and 1330.

Compared to FIG. 9 in which the 3D objects 922, 924, 926, 928 and 930 are displayed in the same size although at different depths, to which the present invention is not limited, the 3D objects 1322, 1324, 1326, 1328 and 1330 may be displayed in different sizes according to their depths, as illustrated in FIG. 13. As a 3D object is deeper, the 3D object may be displayed larger.

In FIG. 13, the 3D objects 1322, 1324, 1326, 1328 and 1330 may be displayed in such a manner than the 3D object 1326 representing the set-top box is deepest and largest the 3D objects 1311 and 1330 representing the camera and the game console, respectively are least deep and smallest, and the 3D objects 1324 and 1328 representing the PMP and the DVD player respectively are medium in depth and size.

As described before, among a plurality of 3D objects, a 3D object representing a latest connected external device, a 3D object representing an external device that ranks highest in connection frequency or connection duration, or a 3D object representing a new connected external device may be deeper than another 3D object. Also, the 3D objects may be displayed in different sizes according to one of the connection statuses, connection frequencies, and connection durations of the external devices corresponding to the 3D objects.

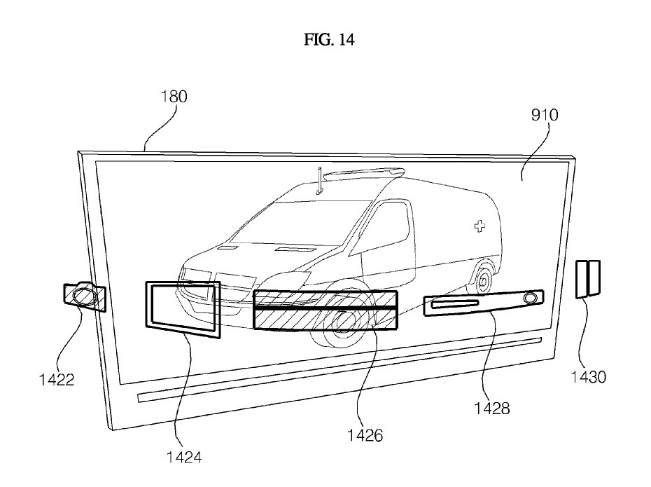

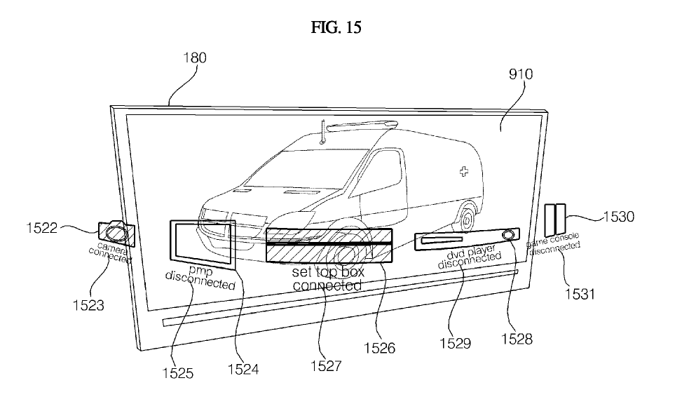

FIGS. 14 and 15 illustrate displaying of 3D objects representing unconnected external devices together with 3D objects representing unconnected external devices over the image 910 on the display 180.

The 3D objects representing the connected external devices may be distinguished from the 3D objects representing the unconnected external devices by at least of brightness, transparency, and color.

Referring to FIG. 14, 3D objects 1422 and 1426 representing connected external devices are displayed at a different transparency level from 3D objects 1424, 1428 and 1430 representing unconnected external devices.

Referring to FIG. 15, 3D objects 1522 and 1526 representing connected external devices are distinguished from 3D objects 1524, 1528 and 1530 representing unconnected external devices by use of different transparency levels, and connection-indication text information 1523 and 1527 and disconnection-indication text information 1525, 1529 and 1531.

In addition, the names of the external devices corresponding to the 3D objects such as camera, pmp, set top box, dvd player, and game controller may be displayed as illustrated in FIG. 15. Therefore, the user can intuitively identify the connected external devices.

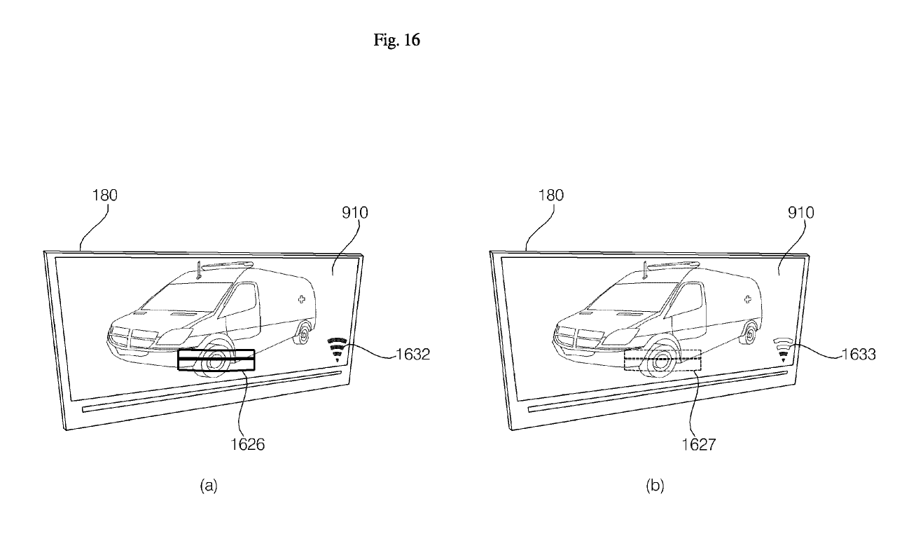

FIG. 16 illustrates displaying of a 3D object representing an external device which is changed in at least one of size, brightness, transparency, color, and shaking according to the connection status of the external device to the image display apparatus 100, over the image 910 on the display 180.

In a good radio environment, a 3D object 1626 corresponding to a set-top box is displayed clear as illustrated in FIG. 16(a), whereas in a poor radio environment, a 3D object 1627 representing the set-top box is displayed dim as illustrated in FIG. 16(b). Wireless connection icons 1632 and 1633 representing the radio environments may further be displayed on the display 180.

The controller 170 may identify the connection status of an external device based on the signal strength of a radio signal received from the external device.

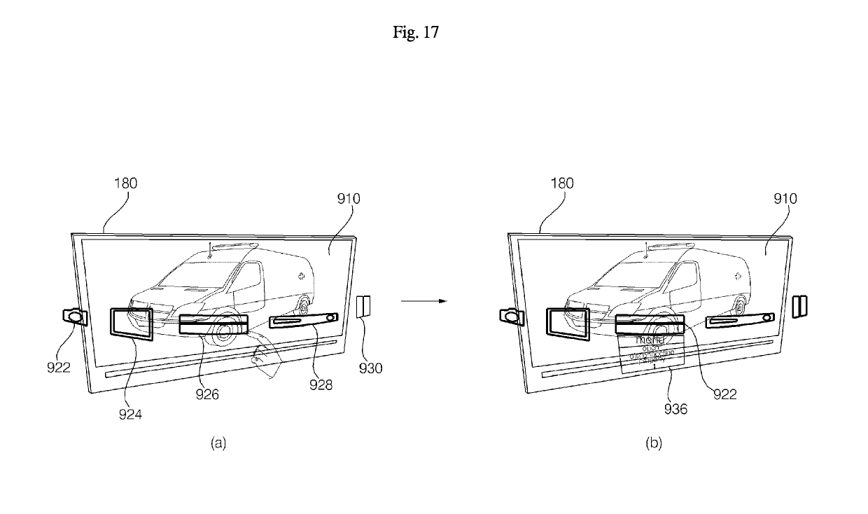

FIG. 17 illustrates displaying of a management menu 936 of the external device corresponding to the 3D object 926 selected from among the displayed 3D objects 922, 924, 926, 928 and 930.

The management menu 936 may be displayed as a pull-down menu as illustrated in FIG. 17, to which the present invention is not limited. Alternatively or additionally, the management menu 936 may be a pop-up menu. It is possible to display the management menu 936 in a sliding manner, such that the management menu 936 appears in place of the selected 3D object 926 which is disappearing.

This management menu 936 may be a 3D object and thus have a different depth from the image 910 displayed on the display 180.

While the management menu 936 may include various menu items, it is shown to have “Open” for opening a file in the external device, “Disconnection” for releasing the connection of the external device from the image display apparatus 100, and “Property” indicating the property of the external device, by way of example.

A 3D object may be selected by a user gesture or an input from the remote control device 200. Thus the user may invoke many functions in relation to the connected external device.

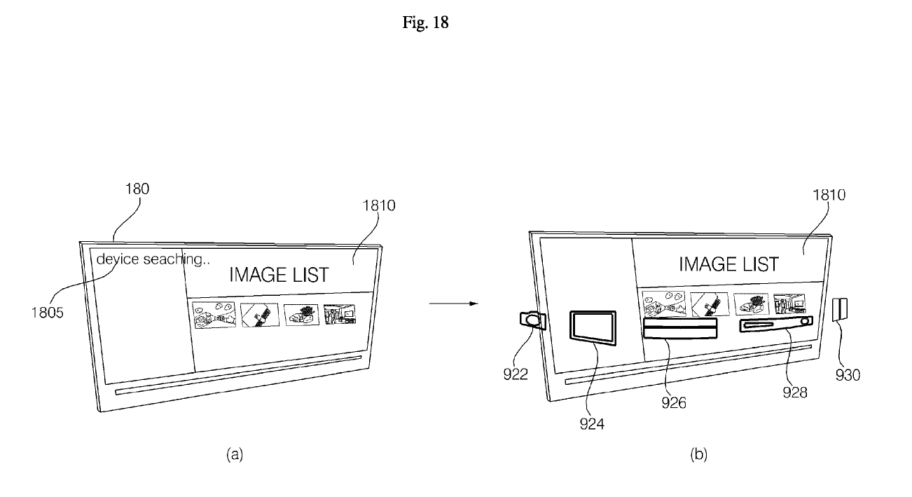

FIG. 18 illustrates detection of the connection of an external device in the image display apparatus 100.

Referring to FIG. 18(a), the image display apparatus 100 searches for a connected external device, while an image 1810 is displayed on the display 180. An object 1805 indicating that external devices are being searched may be displayed on the display 180.

The controller 170 may determine whether an external device has been connected based on the amount of data transmitted to and received from the external device, the strength of a signal received from the external device, or power supplied to the external device (e.g. USB power 5V).

The external device may be connected wireles sly or wiredly through the external signal I/O portion 130 illustrated in FIG. 1.

Referring to FIG. 18(b), the controller 170 generates the 3D objects 922, 924, 926, 928 and 930 representing the connected external devices according to the search results and displays them. As stated before, the 3D objects 922, 924, 928 and 930 may be displayed differently according to the connection statuses of the external devices corresponding to the 3D objects 922, 924, 928 and 930.

The image display apparatus and the operation method therefor according to the foregoing exemplary embodiments are not restricted to the exemplary embodiments set forth herein. Therefore, variations and combinations of the exemplary embodiments set forth herein may fall within the scope of the present invention.

The operation method of an image display apparatus according to the foregoing exemplary embodiments may be implemented as a code that can be written on a computer-readable recording medium and can thus be read by a processor. The computer-readable recording medium may be any type of recording device in which data is stored in a computer-readable manner.

Examples of the computer-readable recording medium include a ROM, a RAM, a CD-ROM, a magnetic tape, a floppy disc, an optical data storage. The computer-readable recording medium can be distributed over a plurality of computer systems connected to a network so that a computer-readable code is written thereto and executed therefrom in a decentralized manner. Functional programs, code, and code segments needed for realizing the embodiments herein can be construed by one of ordinary skill in the art.

According to one or more of the aforementioned exemplary embodiments, a 3D object representing an external device is displayed at a different depth from an image displayed on a display. Thus a user can view the object representing the external device with the illusion of 3D.

Since 3D objects representing connected external devices are scrolled or rotated on the display, user convenience is increased in selecting an external device.

3D objects are displayed differently or at different depths according to the connection statuses, connection frequencies, or the like of external devices corresponding to the 3D objects. Hence, the user can intuitively identify the statuses of the external devices.

When a 3D object is selected, a management menu of an external device corresponding to the 3D object is displayed. Accordingly, management of and access to the external device are facilitated.

Finally, as 3D objects representing external devices are displayed, the user can view the 3D objects while enjoying an image displayed on the display without disturbance.

One or more embodiments described herein provide an image display apparatus and an operation method therefore, which increase user convenience.

One or more embodiments described herein also provide an image display apparatus and method for displaying an object representing an external device with the illusion of 3D.

According to one aspect, there is provided a method for operating an image display apparatus that receives a 3D image signal and displays the 3D image signal as a 3D image, which includes displaying an image, detecting a connected external device, generating a 3D object representing the connected external device, and displaying the 3D object. The 3D object is processed to have a different depth from the displayed image.

According to another aspect, there is provided an apparatus for receiving a 3D image signal and displaying the 3D image signal as a 3D image, which includes a controller for outputting an image signal by processing an input signal, and generating a 3D object representing a connected external device, and a display for displaying the 3D object and displaying the image signal received from the controller as an image. The 3D object is processed to have a different depth from the image.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A three-dimensional (3D) image display apparatus capable of being connected to external devices, comprising:
a display module configured to display images on a screen;
a communication module; and
a controller operatively connected to the display module and the communication module, the controller configured to control the 3D image display apparatus to generate and display a 3D object representing an external device physically or wirelessly connected or connectable to the 3D image display apparatus.

2. The 3D image display apparatus of claim 1, wherein the controller is configured to control the 3D image display apparatus to generate and display two separate 3D objects representing two separate external devices physically or wireles sly connected or connectable to the 3D image display apparatus.

3. The 3D image display apparatus of claim 2, wherein the controller is configured to scroll or rotate the two separate 3D objects.

4. The 3D image display apparatus of claim 2, wherein the controller is configured to vary corresponding depths of the two separate 3D objects so as to indicate which of the two separate external devices was last connected or ranks highest in connection frequency or connection duration.

5. The 3D image display apparatus of claim 2, wherein the controller is configured to vary one of a 3D object size, brightness, transparency, color, and shaking according to one of an external device connection status, connection frequency, connection order, and connection duration.

6. The 3D image display apparatus of claim 2, wherein the controller is configured to display the two separate 3D objects in a fish eye pattern.

7. The 3D image display apparatus of claim 1, wherein the controller is configured to control the 3D image display apparatus to generate and display a 3D object representing an external device physically or wirelessly connectable but not connected to the 3D image display apparatus with one of a depth, a size, a brightness, a transparency, and a color different from a depth, a size, a brightness, a transparency, and a color of a 3D object representing an external device physically or wirelessly connected to the 3D image display apparatus.

8. The 3D image display apparatus of claim 7, wherein the controller is configured to control the 3D image display apparatus to display one of a 3D object name and a 3D object connection status.

9. The 3D image display apparatus of claim 1, wherein the controller is configured to display a device management menu in response to a user selection of the external device, the user selection being one of a signal from a remote controller and a motion sensed by a motion sensor associated with the 3D image display device.

10. The 3D image display apparatus of claim 9, wherein the controller is configured to display the device management menu as a corresponding 3D menu object, the 3D menu object displayed at a depth different from or equal to the 3D object representing the external device.

11. The 3D image display apparatus of claim 1, wherein the controller is configured to change a display characteristic of the 3D object representing the external device in response to a change in connection status.

12. A method of operation a three-dimensional (3D) image display apparatus having a display, a communication module and a controller, the 3D image display apparatus capable of being connected to external devices, the method comprising:
displaying images on the screen; and
generating and displaying a 3D object representing an external device physically or wirelessly connected or connectable to the 3D image display apparatus.

13. The method of claim 12, wherein the step of generating and displaying a 3D object comprises:
generating and displaying two separate 3D objects representing two separate external devices physically or wirelessly connected or connectable to the 3D image display apparatus.

14. The method of claim 13, further comprising:
scrolling or rotating the two separate 3D objects.

15. The method of claim 13, further comprising:
varying corresponding depths of the two separate 3D objects so as to indicate which of the two separate external devices was last connected or ranks highest in connection frequency or connection duration.

16. The method of claim 13, further comprising:
varying one of a 3D object size, brightness, transparency, color, and shaking according to one of an external device connection status, connection frequency, connection order, and connection duration.

17. The method of claim 13, wherein the step of generating and displaying two separate 3D objects comprises:
displaying the two separate 3D objects in a fish eye pattern.

18. The method of claim 12, wherein the step of generating and displaying a 3D object comprises:
generating and displaying a 3D object representing an external device physically or wirelessly connectable but not connected to the 3D image display apparatus with one of a depth, a size, a brightness, a transparency, and a color different from a depth, a size, a brightness, a transparency, and a color of a 3D object representing an external device physically or wirelessly connected to the 3D image display apparatus.

19. The method of claim 18, further comprising:
displaying one of a 3D object name and a 3D object connection status.

20. The method of claim 12, further comprising:
displaying a device management menu in response to a user selection of the external device, the user selection being one of a signal from a remote controller and a motion sensed by a motion sensor associated with the 3D image display device.

21. The method of claim 20, wherein the step of displaying a device management menu comprises:
displaying the device management menu as a 3D menu object at a depth different from or equal to the 3D object representing the external device.

22. The method of claim 12, further comprising:
changing a display characteristic of the 3D object representing the external device in response to a change in connection status.
